(19) United States
(12) Patent Application Publication
(10) Pub. No.: US 2025/0139191 A1
(43) Pub. Date: May 1, 2025

(54) Systems and Methods of Floating-Point Vector Operations for Neural Networks and Convolutions

(71) Applicant: Expedera, Inc., Santa Clara, CA (US)

(72) Inventors: Yash Niki Mehta, Farmington Hills, MI (US); Jacqueline Chuang, Los Altos, CA (US); Suhail Ibrahim Alnahari, Merced, CA (US); Ramteja Tadishetti, Sunnyvale, CA (US); Steve Fu, Palo Alto, CA (US)

(21) Appl. No.: 18/496,689

(22) Filed: Oct. 27, 2023

(51) Int. Cl. G06F 17/16

(52) U.S. Cl. CPC G06F 17/16

(57) ABSTRACT

A method for generating in semiconductor hardware a dot product of two floating-point vectors. The method accesses the elements of the two vectors and performs a multiply in hardware. Before performing the multiply, the exponents of the elements can be checked to determine if the result would exceed the range of the fixed-point accumulator and the multiplication of the elements skipped if exceeded. The elements passing the optional check are multiplied. The resulting product is converted to a fixed-point number and summed with an accumulator. The dot product hardware can be part of an integrated semiconductor implementation of a neural network.

### TECHNICAL FIELD

The present application relates to the field of specialized semiconductor circuits and electronic hardware, providing devices and methods for improved efficiencies for tensor operations, including vector dot products. Vector dot product operations form the basis of tensor operations, including convolution and computations within a neural network. Tensor multiplications are comprised of multiple vector dot product operations. The devices are directed at semiconductor implementations that are more efficient in the use of semiconduction real estate and power and processing speed. These operations are commonly used in image processing convolution functions and in neural networks.

### BACKGROUND

It should not be assumed that any of the approaches described in this section qualify as prior art merely by virtue of their inclusion in this section. The computation of a dot product of two floating-point vectors can be compute and power intensive and require significant semiconductor real estate when complying with IEEE standards. What is needed are methods and digital semiconductor structures that improve the processing speed, power utilization, and semiconductor utilization for hardware that performs floating-point dot products for applications, including convolution and neural networks.

### SUMMARY

This summary is provided to introduce a selection of concepts in a simplified form that is further described below in the Detailed Description of Example Embodiments. This summary is not intended to identify key features or essential features of the claimed subject matter, nor is it intended to be used as an aid in determining the scope of the claimed subject matter.

In one aspect of the invention, a method for generating in hardware a dot product of two floating-point vectors is disclosed. The method comprises accessing from a memory, elements from a first vector, and elements from a second vector. In digital semiconductor hardware, floating-point multiply is performed on the respective elements from the first vector and the second vector. The resulting floating-point product is converted to a fixed-point representation of the floating-point product.

In some embodiments, before performing the floating-point multiply, the multiplicand and multiplier elements are checked to determine if the resulting product is out of range of the conversion to a fixed-point result. If out of range, the multiplication is not performed, saving both computation time and the power that occurs when toggling gates during a multiply operation. This range check can be performed by checking the exponents of the elements being multiplied.

Next, the hardware multiplication product is converted to a fixed-point integer with a predetermined number of bits representing integer values and a predetermined number of bits representing fractional values. Optionally, if the multiplication product is out of range, then this step is not performed.

Next, the converted fixed-point integer is added by a hardware accumulator to an accumulation value.

### BRIEF DESCRIPTION OF THE DRAWINGS

Exemplary embodiments are illustrated by way of example and not limited by the figures of the accompanying drawings, in which like references indicate similar elements.

FIG. 1—Shows an example bit organization for a sixteen-bit floating-point number.

FIG. 2—Shows examples of the fixed-point number.

FIG. 3—Is a is a flowchart for providing a method for efficiently performing a dot product of two vectors.

FIG. 4—Is an example of a system for performing the dot product of floating-point vectors.

FIG. 5—Is a diagram of a weighted sum neural node performed by a floating-point dot product.

### DETAILED DESCRIPTION OF EXAMPLE EMBODIMENTS

The following detailed description includes references to the accompanying drawings, which are a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, functional, logical, and electrical changes can be made without departing from the scope of what is claimed. The following detailed description is, therefore, not to be taken in a limiting sense, and the scope is defined by the appended claims and their equivalents.

Data representation in computer memory can be very different. A floating point representation of 12.5=1.25*10¹=12.5000, but in computer memory can be represented in different ways including IEEE compliant floating point number or an integer representation. This is important because the representation affects the space required to represent a number and the processing speed required to do multiplications and additions.

For example, but not by way of limitation, two representations of data include FP-16 (floating-point 16) and a 16-bit representation. Other size representations of floating-point numbers are contemplated, including FP-32, and FP-64.

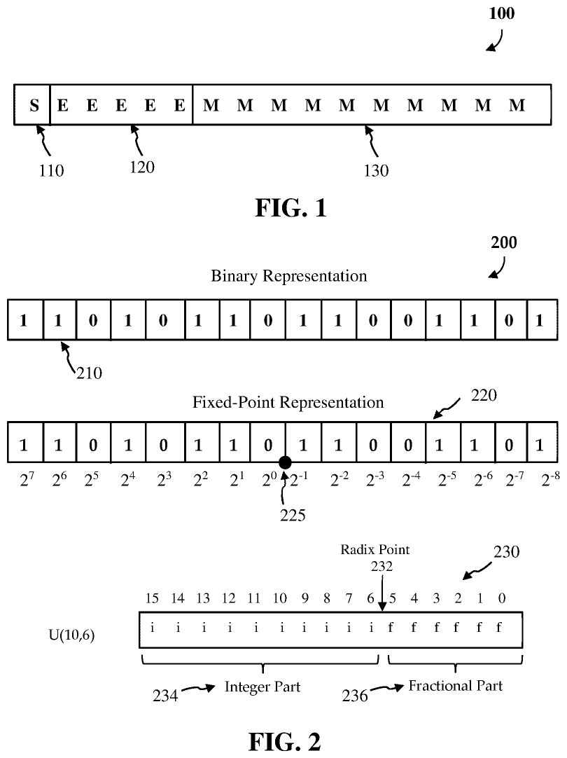

Referring to FIG. 1 is a depiction 100 of the FP-16 number organization. There is a sign bit 110, positive or negative. Five bits 120 are used for the exponent, which is the value that we raise two to in scientific notation. Ten bits 130 for the mantissa, which are the significant bits of the decimal. For the IEEE format, there is an implied value of “1” in front of the mantissa.

The processing steps required to perform a floating-point multiply are straight forward. As shown below, the exponents are added together and the mantissas multiplied.

$$\begin{matrix}Multiply 4. \times {10}^{- 7} * 3 , 250 , 000 , 000 = ( 4 * {10}^{- 7} ) ( 3.25 * {10}^{9} ) \\ = ( 4 * 3.25 ) ( 1 {0}^{- 7} * {10}^{9} ) \\ = 13 * {10}^{2}\end{matrix}$$

$$= 1300$$

The approach for floating point multiplies does not need to be changed. However, the addition of floating point numbers is more complicated. Before adding, the decimal part of the number needs to be shifted based on the exponent value, which makes the addition process slower.

Another optimization that can be implemented in generating a semiconductor hardware floating-point vector dot production is to reduce the steps required by a floating-point multiply. Typically, floating-point multiplication circuit consists of a multiplier for the mantissa, an adder for exponent, followed by shifting, rounding, and normalizing logic. When taking the result for floating-point multiplication and converting it into a fixed-point representation-some of the operations performed by rounding & normalizing are overall unnecessary. Instead, the intermediate result that is created after the floating-point multiplier & adder are directly converted into fixed-point representation. This will involve a comparison of the exponent and then shifting logic to correctly shift the multiplier result to a proper decimal place.

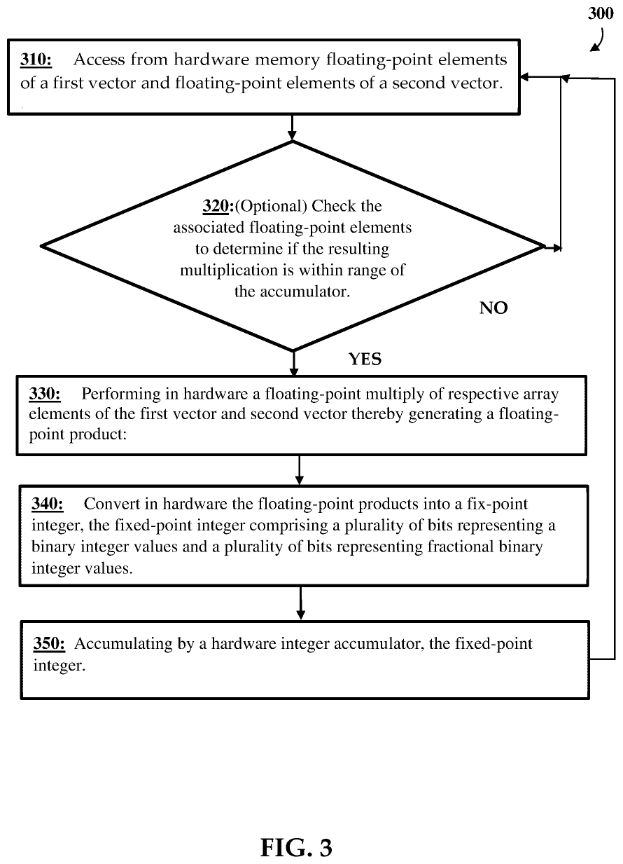

FIG. 3 shows a flow chart 300 of a process of performing a dot product of two floating-point vectors in a computationally efficient manner. This efficiency includes faster computational speed, less semiconductor real estate required, and less power required.

In step 310, the floating-point elements of a first vector and the elements of a second vector are received. These are the elements from which a dot product computation is to be performed efficiently in hardware.

In optional step 320, a check is made to determine if the multiplication of the respective elements of the dot product is out of bounds of the hardware accumulator. This can be performed by checking the exponents of the two floating-point numbers in the dot product that are to be multiplied. For example, the accumulator may only support numbers as small as the number of fractional digits allocated in an integer. For example, 2⁻⁸ may be the smallest number for 16-bit accumulator or 2⁻¹⁶ for a 32-bit accumulator. Thus, if the result of the multiplication of two elements within a dot product is going to be less than this value, it is a waste of processing time and power to perform the multiply and accumulation because it will have no impact on the final result in the accumulator.

Additionally, if the multiplication of the respective element of the dot product is beyond the range of the accumulator, then the accumulate can be set to the max value. This check can also be made by checking the exponents of the two floating-point numbes in the dot product that are to be multiplied. Again, this saves the power and time of doing a full multiply.

If the multiply is not within the range of the accumulator, then the process returns to step 310 to check the multiplication of the next elements to be multiplied in the dot product array.

In step 330, the floating point multiply of the respective elements is performed.

In step 340, the floating point multiply result is converted into a fixed-point integer compatible with the configuration for integer and fractional portion of the fixed-point integer accumulator.

In step 350, the converted fixed point multiple result is added to the accumulator. The process continues at step 310 with the processing of the next pair of respective vector elements to be multiplied and accumulated. The process finishes once the end of the vector is reached.

Not shown, the process can include conversion by a hardware implementation of the resulting accumulation from a fixed-point number back into a floating-point number.

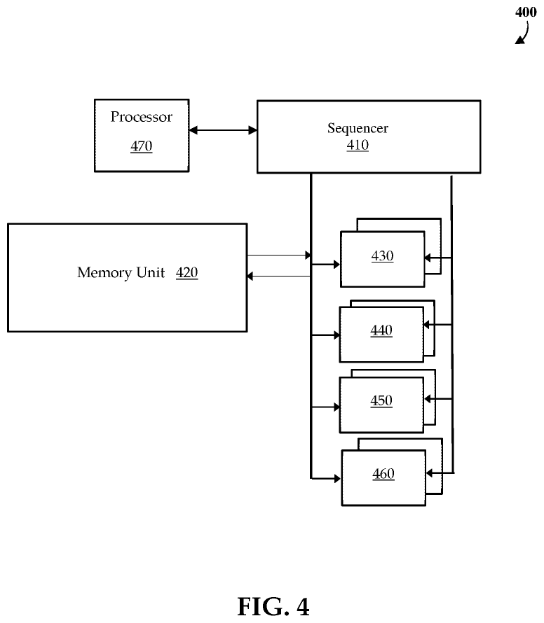

FIG. 4 provides a system block diagram 400 of semiconductor logic blocks configured to perform efficient floating-point vector dot products in customized semiconductor digital hardware. The system can include a processor 470, a sequencer 410, a memory unit 420, optional test logic for performing the multiply and accumulation operation 430, computational logic including one or more floating-point multipliers 435, one or more semiconductor logic testing 440, one or more conversion of floating-point numbers to fixed-point numbers 450, and one or more accumulators 460.

The processor 460 can provide high-level control for providing different applications that include floating point generating vector dot products. These applications can include but are not limited to convolutions and neural networks. The processor 460 can be a digital signal processor, a microprocessor, a neural processor, or other customized computational logic suitable for the above-mentioned functions.

The sequencer 410 includes the microelectronics required to control the data flow for flow from memory to the logic processing components, including but not limited to logic for determining whether a floating-point multiple and accumulation should be performed 430, one or more floating-point multipliers 435, one or more semiconductor logic testing 440, one or more semiconductor conversion logic of floating-point numbers to fixed-point numbers 450, and one or more accumulators 460. The sequencer 410 can also provide control over the memory unit 420 for the flow of data and control the data flow and sequence of processing through logic blocks 430, 440, 450 and 460. A POSITA (person of ordinary skill in the art) of digital semiconductor would know how to design a sequencer and the associated hardware to control the data flow from memory to and from the associated hardware to implement a dot product calculation.

The memory unit 420 can include a plurality of memory blocks to support applications where parallel processing is applicable. These applications can include image convolution processing or neural nodes in a neural network.

The floating-point multipliers 430 can be a semiconductor representation of an IEEE compliant floating-point multiply. The multiplier can be for 16, 32, 64-bit, or more floating-point numbers. The multiplier can include the process as described above that eliminates steps not needed when generating a fixed-point number from the floating-point number. The hardware logic for determining whether a floating-point multiply and accumulation should be performed 440 can be replicated for each multiplier 430. The results are fed back to the sequencer to control the process.

The one or more semiconductor conversion logic of floating-point numbers to fixed-point numbers 450 can be provided for each multiplier.

The one or more accumulators 460 are implemented in semiconductor hardware. The accumulator can be of any size but preferably is at least 16-bits. The decimal point can be at any bit location.

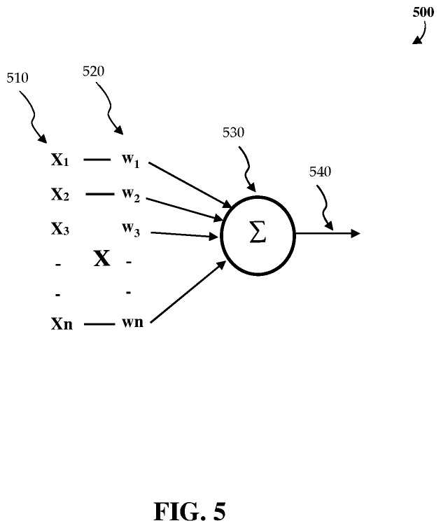

Referring to FIG. 5, a node 500 is depicted that could reside within a hardware implementation of a neural network. This processing can perform a dot product between an input vector 510 and a weight vector 520. The results of each multiply, X₁*w₁, for example are summed by the accumulator 530. The resulting output 540 can be either a floating point number or a fixed point number.

The corresponding structures, materials, acts, and equivalents of all means or step plus function elements in the claims below are intended to include any structure, material, or act for performing the function in combination with other claimed elements as specifically claimed. The description of the present technology has been presented for the purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

Aspects of the present technology are described above with reference to flowchart illustrations and/or block diagrams of methods and apparatus (systems) according to embodiments of the present technology.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or combinations of special purpose hardware.

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment,” “in an embodiment,” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms, and a plural term may include its singular form. Similarly, a hyphenated term (e.g., “on-demand”) may occasionally be interchangeably used with its non-hyphenated version (e.g., “on-demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments, the “means for” is expressed in terms of a mathematical formula, prose, or as a flow chart or signal diagram.

The terminology used herein is for the purpose of describing particular embodiments only and is not intended to be limiting of the invention. As used herein, the singular forms “a,” “an,” and “the” are intended to include the plural forms as well unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purposes only and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for generating a dot product of two vectors, the method comprising:
accessing from a memory floating-point elements of the first vector and elements of the second vector;
performing in hardware a floating-point multiply respective array elements of the first vector and second vector thereby generating a floating-point product:
converting in hardware the floating-point products into a fix-point integer, the fixed-point integer comprising a plurality of bits representing a binary integer values and a plurality of bits representing fractional binary integer values; and
accumulating by a hardware integer accumulator, the fixed-point integer.

2. The method of claim 1, further comprising:
checking in hardware that the floating-point product is out of range of the integer accumulator, wherein the floating-point multiplication, the conversion, and the fixed-point accumulation is not performed if out of range.

3. The method of claim 2, wherein the performing of the check of each floating-point multiplication is performed by examination of the floating-point exponents of the input-tensor values and the kernel-tensor values.

4. The method of claim 3, wherein the check of the floating-point products range check includes whether the results would be above or below the range of the integer accumulator.

5. The method of claim 1, further comprising:
using an accumulator with a larger range if the accumulation overflows the accumulator.

6. The method of claim 1, wherein the fixed-point integer is between sixteen and sixty-four bits.

7. The method of claim 6, wherein half the bits are used to represent the fractional binary value.

8. The method of claim 1, wherein one of the two vectors is an input into a layer of a neural network and the other of the two vectors is a weight vector of a neural network and the dot product generates an input to another layer of the neural network, or an output of the neural network.

9. The method of claim 1, wherein the floating point multiply and integer accumulator are implemented as part of a semiconduction circuit.

10. A hardware system for generating a dot product of two tensors, the dot product generation comprising:
a hardware floating-point multiplier;
a hardware integer accumulator;
a sequencer configured to generate a first tensor and second tensor dot product, the tensor dot product comprising a plurality of vectors multiplications and accumulations of a plurality of vector dot products, each vector dot product comprising first vector and a second vector of array of elements, comprising,
the sequencer configured to access floating point elements of the first vector and the second vector, executing the process:
multiplying respective array elements of the first vector and second vector thereby generating a plurality of floating-point products;
converting in hardware the plurality of floating-point products into a plurality of fix-point integer, the fixed-point integer comprising a plurality of bits representing a binary integer values and a plurality of bits representing fractional binary integer values; and
accumulating by the integer accumulators, the plurality of fixed-point integers thereby determining a binary integer vector dot product.

11. The hardware system of claim 10, further comprising:
checking the plurality of floating-point products to determine if the multiplication products are out of range of the integer accumulator, wherein the floating-point multiplication, the conversion, and the fixed-point accumulation is not performed for any floating-point product that is out of range.

12. The hardware system of claim 11, wherein the performing of the check of each floating-point multiplication is performed by examination of the floating-point exponents of the input-tensor values and the kernel-tensor values.

13. The method of claim 12, wherein the check of the floating-point products range check includes whether the results would be above or below the range of the integer accumulator.

14. The hardware system of claim 10, further comprising:
using an accumulator with a larger range if the accumulation overflows the accumulator.

15. The hardware system of claim 10, wherein the fixed-point integer is between sixteen and sixty-four bits.

16. The hardware system of claim 15, wherein half the bits are used to represent the fractional binary value.

17. The hardware system of claim 10, wherein one of the two vectors is an input into a layer of a neural network and the other of the two vectors is a weight vector of a neural network and the dot product generates an input to another layer of the neural network or the output of the neural network.

18. The hardware system of claim 10, wherein the floating point multiply and integer accumulator are implemented as part of a semiconduction circuit.
